(19) United States
(12) Patent Application Publication
(10) Pub. No.: US 2017/0054661 A1
(43) Pub. Date: Feb. 23, 2017

(54) INSTANT MESSAGING SYSTEM TO INTEGRATE DEVICES AND PEOPLE

(71) Applicant: IPG INCREMENTO DE PRODUCTIVIDAD GLOBAL S.A. DE C.V., Mexico DF (MX)

(72) Inventor: Luis Alejandro Golcher Barguil, Cartago (CR)

(73) Assignee: IPG INCREMENTO DE PRODUCTIVIDAD GLOBAL S.A. DE C.V., Mexico DF (MX)

(21) Appl. No.: 14/829,344

(22) Filed: Aug. 18, 2015

(51) Int. Cl. H04L 12/58; G06Q 10/10; H04L 29/08

(52) U.S. Cl. CPC H04L 51/046; H04L 67/02; G06Q 10/1093

(57) ABSTRACT

A method and system An instant messaging system (IMS) that integrates on-line communication between people and devices, between devices and other devices, as well as between people, and that provides real time monitoring of key events and of critical success indicators of the devices, besides providing tools to assign, and to follow-up tasks of related activities.

### FIELD OF THE INVENTION

This invention relates in general to an instant messaging system that integrates on-line communication and that provides real time monitoring of key events and of critical success indicators of the devices connected, besides providing tools to assign, and to follow-up tasks of related activities.

### BACKGROUND OF THE INVENTION

Instant messaging system (IMS) has never before help to integrate on-line communication to provide real time monitoring of key events and of critical success indicators of the devices connected, besides providing tools to assign, and to follow-up tasks of related activities.

Prior art methods for addressing remote monitoring and/or control of peripheral devices include the following:

Dedicated host control software. Such software controls the printing and reports status promptly, but is not suitable for casual end-users, and may not be able to be shared easily among a group of users. Moreover, such software controls the printing and reports status promptly, but is not suitable for general printer configuration and control, and provides a limited ability to submit and report the answers to queries. Additionally, this software is not suitable for client workstation use. And it is generally not convenient for administration of the remote device, because it is optimized for print job management. This software limits only to printers.

Remote operator panel software for client workstations, with special support in the devices to communicate with it. This solution has the disadvantage of requiring the software to be installed on the client workstation.

Simple Network Management Protocol (SNMP) based monitoring software. SNMP support is now common in such peripheral devices, and allows standards-based software to communicate with it, even software from different vendors. This process suffers from the same disadvantages of requiring a special application and dedicated resources on the client computer.

Web-based status reporting in the device. Here a device hosts a web server that provides status and allows for remote configuration of the printer. This requires no client software other that the now nearly-universal web browser. But it does not provide asynchronous status updates unless the user keeps a browser window open to watch the device.

E-mail notification from the device (mainly printers). This requires only the now nearly-universal e-mail client, which can provide asynchronous notification of new e-mails. The disadvantage is that the user must access the e mail program and (unless the status message is brief enough to be included in the subject line) open the e-mail to read the status information. The user must also discard the message after reading it.

Patent WO 2008115995 A1 comprises a Method for managing remote devices over an instant messaging network and systems thereof. However, this prior art does not assign key events to other devices or people, and does not assign tasks to people and follow-up on tasks for that device in order to solve problems and to support continuous improvement, Moreover, the invention does not calculate the device's statistics, plot device's variables and control the device functions. Also the contact list resides on each device which is hard to consolidate in a network of many devices.

Patent US 20050102362 A1 discloses an Instant Messaging support in the device can coexist with and complement the other status features in the device, such as SNMP, web server, e-mail, etc. For existing devices that have e-mail notification software in them, the Instant Messaging software would be most appropriately implemented as an extension of that software. However, the system is not able to provide real time monitoring of key events and of critical success indicators of the devices connected. This invention proposes a software application to be embedded into a device to grant instant messaging communications. Devices send messages using instant messaging communications protocols. But the invention is not an instant messaging system on a server. It needs to be embedded into each device. Patent YS 2014/0173751 proposes a software application to monitor computers on a network. The monitoring is performed by opening chat sessions so that users can access and control machines or computers via the chat messages. This invention does propose an instant messaging system that is able to communicate to devices through its native protocols and they must have enough intelligence to know what an event is. In this invention, the machine must know what is an event to notify it when the chat session is open, it does not define key performance indicators, neither any capabilities to set up and manage tasks between users to solve a problem and it does not provide capabilities to plot the machine's main variables, an engine to process and configure raw data coming from the machine and it does not establish collaboration between users by voice/video calling or file sharing as an instant messaging system. This invention establishes a chat session application, where users have to set up every time with authenticated contacts and machines. It does not provide any framework for machine journals, or comment logs from coming from users, does not provide any infrastructure for mobile applications and it needs machines or computers to have an engine to process their data. In our invention the processing is done in the Instant Messaging Server Engine. This invention does not provide a method of tying events and key performance indicators to people, such as the concepts of ownership and subscription.

### DESCRIPTION OF THE PREFERRED EMBODIMENTS

This invention refers to an instant messaging system (IMS) that integrates on-line communication between people and devices, between devices and other devices, as well as between people, and that provides real time monitoring of key events and of critical success indicators of the devices, besides providing tools to assign, and to follow-up tasks of related activities.

The instant messaging system includes IMS basic services, an event module, a task module, a key performance indicator (KPI) Module, a trending module, a calendar module, a notification module, a configuration manager, a data base connector, a desktop client connector, a mobile client connector, and a device protocol connector.

The system allows that the key events, the indicators, and the tasks are stored primarily in the IMS and, if available, in the device's binnacle or device journal. Any key event, indicator, and/or the tasks can generate information in graphics, timelines, tables, statistics and data according to the criteria included in the IMS.

According to the present invention, the tasks can be assigned to a responsible person and to at least one additional user that will also be able to receive and follow-up the task. The event, the indicators, and the tasks can be generated either by a person or by a device.

The device that communicates with the IMS, can be any industrial machine, any programmable logic controller, any dedicated controller system, and even the process equipment such as factory machinery and process equipment, as well as mechanical, electrical or electronic equipment such as computers, microprocessor-based systems, or software applications like supervisory control and data acquisition systems, data historians, manufacturing execution systems, human/machine interfaces, workflow management, and similar software applications.

The IMS allows communication through a mobile client component that has access buttons to event logger, process variable plots, process diagrams, task indicators, indicators, messages, user's contacts and device list, user groups areas, area for displaying users and devices in a tree-view or traditional diagram in order to add them as contacts and a conversation area.

The pop-up window for creating a task allows creating at least the following tasks: selecting user, filtering users (by name, job position, department, physical area and any other variable), selecting an activity type or template or any other descriptor, selecting a delivery date, appointing task name and comments and buttons to create a task or cancel it. However, it can also allow including any other tasks.

The plot process variable has a space for filtering process variables by name, an area for variable list grouped by areas, and an area for polling process variables either analogue or discrete. The event and KPI log in the IMS comprises an area to show the log for events and KPI triggering and a space for time frame selection.

The pop-up window for process graphics and device control includes an area to show process graphics, an area to control process variables, and an area to show monitored values.

In this process, collaboration can be done of texting and talking between users, of automatically gathering a device's data, of being notified of triggering events, of assigning tasks to users and following-up, of controlling devices, of viewing the trends in process variables and the process graphics, and of getting key performance indicators for the devices.

As a summary, the Instant Messaging System comprises three main application components: Server, Mobile Client and Desktop Client.

The Server component is the application engine that executes the features and functions which allow the Instant Messaging to perform. The Mobile Client presents the interface to users via mobile apparatus such as tablets, smart phones or similar devices. Finally, the Desktop Client is the interface for users using notebooks, laptops or desktop computers, and where the Server is mainly composed of a Configuration Manager and an Engine.

A Configuration Manager allows a system administrator to create, add, edit or delete device events, device key performance indicators, device process variables, device process graphics, tasks templates, users, organizational diagram with job positions/departments/physical locations, user and device calendars and notifications methods for users.

The System Administrator can create, add, edit or delete events through the Configuration Manager. In order to do so, an event is stated as a change in a device condition. Events are active if the defined condition becomes true, such as if a device variable becomes bigger than a predefined value. Every event is tied to an owner, so that when the event triggers, the owner can be properly notified. Other users can be notified, if they have subscribed to that event. Users can unsubscribe to events at any time. The owner of the event is the only one who cannot unsubscribe to it.

The System Administrator can create, add, edit, and delete key performance indicators through the Configuration Manager. Every key performance indicator is tied to an owner, so that when the indicator triggers, the owner can be properly notified. Other users can be notified, if they have subscribed to that indicator. Users can unsubscribe to indicators at any time; only the owner of the indicator cannot unsubscribe to it.

The System Manager can create, add, edit, delete calendar templates through the Configuration Manager that are used to describe the user working hours or to describe the device active schedule.

The process' variables are available to users for plotting through the Configuration Manager. The System Administrator can draw graphics that will be associated with devices' process graphics windows.

The System Administrator can create through the Configuration Manager, user groups of one or more users and of one or more devices, and define tasks templates where users can assign predefined tasks to other users. Is the System Administrator the one that defines, through the Configuration Manager, which device data, and its format, would be recorded in the device journal, or which data a device reads from another device, as well as which data needs to be written to another device. The Configuration Manager stores all configuration information in the database.

The Server Engine provides the Instant Messaging System with basic services such as user texting, user voice and video call conversations and file sharing between users. The Server Engine continually reads the devices' raw data through the protocol connectors and processes it into useful information. It then makes the processed data available to the System Administrator where events, indicators, process variables, and similar actions can used this information.

The Server Engine is a single unit that has six independent modules to perform different functions. The modules are: Event Module, KPI Module, Trending Module, Task Module, Calendar Module, and Notification Module.

The Event Module supervises the different events' triggering conditions and, when a defined event activates, it sends the request for notification to the Notification Module.

The Key Performance Indicator Module supervises the different indicators' values and, when an indicator value goes beyond its limits, it sends a request for notification to the Notification Module.

The Trending Module stores the values for the selected process variables of the devices and for the selected time frame.

The Task Module handles all the transactions that are need for the tasks' management, and it can also create automatically new tasks upon the triggering of an event.

The Calendar Module continually verifies that users are on working hours, as well as determining if the devices are on their active schedule.

The Notification Module notifies users about alerts regarding events, key performance indicators and tasks. The notification is conducted via email, Short Message Service, and through a special Contact that all users have in their IMS. This Contact notifies users about the alerts of the events and the alerts of the key performance indicators that they own or, to which they have subscribed, as well as notifying the users of new tasks that have been assigned to them. Users can select if they want to be notified out of working hours.

The Server Engine records messages and data, in the predefined format, on each device journal, and continually provides data and supports services to the Instant Messaging Client Component Connectors so that users can keep in touch and updated.

Through the Instant Messaging System Client, people in real time can, for each device contact, read each device operation journal, as well as people's comments on that device, plot process variables related to it, view the device's animated process graphics, get the devices' main key performance indicators, be notified of the devices' events he/she owns, or to which he/she has subscribed, along with the specific date and time. It can also assign tasks to people and follow-up on tasks for that device in order to solve problems and to support continuous improvement, get the device's statistics, and control the device functions.

With this system, people can (in real time, for each user contact) text message, voice call, video call, assign and follow-up tasks in order to solve problems and support continuous improvement, follow-up delegated tasks, and/or get the key performance indicators for an area or group of people.

Each and every device can, in real time for each device, read data from a device and control at least one device function.

The foregoing description of the exemplary embodiment of the invention has been presented for the purposes of illustration and description. It is not intended to be exhaustive or to limit the invention to the precise steps disclosed. Many modifications and variations are possible in light of the above teaching. It is intended that the scope of the invention be limited not with this detailed description, but rather by the claims appended hereto.

1. An instant messaging system (IMS) that integrates on-line communication between people and devices, between devices and other devices, as well as between people, and that provides real time monitoring of key events and of critical success indicators of the devices, besides providing tools to assign, and to follow-up tasks of related activities.

2. The instant messaging system of claim 1, comprising: IMS basic services, an event module, a task module, a key performance indicator (KPI) Module, a trending module, a calendar module, a notification module, a configuration manager, a data base connector, a desktop client connector, a mobile client connector and a device protocol connector.

3. The instant messaging system of claim 1, where the key events, the indicators, and the tasks are stored primarily in the IMS and, if available, in the device's binnacle or device journal.

4. The instant messaging system of claim 1, where the key events, the indicators, and the tasks can generate information in graphics, timelines, tables, statistics and data according to the criteria included in the IMS.

5. The instant messaging system of claim 1, where the tasks are assigned to a responsible person and to at least one additional user that will also be able to receive and follow-up the task.

6. The instant messaging system of claim 1, where the event, the indicators, and the tasks can be generated either by a person or by a device.

7. The instant messaging system of claim 1, where the device that communicates with the IMS, can be any industrial machine, any programmable logic controller, any dedicated controller system, and even the process equipment such as factory machinery and process equipment, as well as mechanical, electrical or electronic equipment such as computers, microprocessor-based systems, or software applications like supervisory control and data acquisition systems, data historians, manufacturing execution systems, human/machine interfaces, and similar software applications.

8. The instant messaging system of claim 2, where the IMS allows communication through a mobile client component comprising: access buttons to event logger, process variable plots, process diagrams, task indicators, indicators, messages, user's contacts and device list, user groups areas, area for displaying users and devices in a tree-view or traditional diagram in order to add them as contacts and a conversation area.

9. The instant messaging system of claim 2, where the pop-up window for creating a task allows creating at least the following tasks: selecting user, filtering users (by name, job position, department, physical area and any other variable), selecting an activity type or template or any other descriptor, selecting a delivery date, appointing task name and comments and buttons to create a task or cancel it.

10. The instant messaging system of claim 2, where the plot process variable comprises: a space for filtering process variables by name, an area for variable list grouped by areas, and an area for polling process variables either analogue or discrete.

11. The instant messaging system of claim 2, where the event and KPI log in the IMS comprises an area to show the log for events and KPI triggering and a space for time frame selection.

12. The instant messaging system of claim 2, where the pop-up window for process graphics and device control includes an area to show process graphics, an area to control process variables, and an area to show monitored values.

13. The instant messaging system of claim 1, where collaboration can be done of texting and talking between users, of automatically gathering a device's data, of being notified of triggering events, of assigning tasks to users and following-up, of controlling devices, of viewing the trends in process variables and the process graphics, and of getting key performance indicators for the devices.

14. An Instant Messaging System comprising three main application components: Server, Mobile Client and Desktop Client, where the Server component is the application engine that executes the features and functions which allow the Instant Messaging to perform, the Mobile Client presents the interface to users via mobile apparatus such as tablets, smart phones or similar devices, and the Desktop Client is the interface for users using notebooks, laptops or desktop computers, and where the Server is mainly composed of a Configuration Manager and an Engine.

15. The Instant Messaging System of claim 14, where the Configuration Manager allows a system administrator to create, add, edit or delete device events, device key performance indicators, device process variables, device process graphics, tasks templates, users, organizational diagram with job positions/departments/physical locations, user and device calendars and notifications methods for users.

16. The Instant Messaging System of claim 14, where the System Administrator can create, add, edit or delete events through the Configuration Manager according to the following process: an event is stated as a change in a device condition, events are active if the defined condition becomes true, such as if a device variable becomes bigger than a predefined value. Every event is tied to an owner, so that when the event triggers, the owner can be properly notified. Other users can be notified, if they have subscribed to that event. Users can unsubscribe to events at any time. The owner of the event is the only one who cannot unsubscribe to it.

17. The Instant Messaging System of claim 14, where the System Administrator can create, add, edit, delete key performance indicators through the Configuration Manager. Every key performance indicator is tied to an owner, so that when the indicator triggers, the owner can be properly notified. Other users can be notified, if they have subscribed to that indicator. Users can unsubscribe to indicators at any time; only the owner of the indicator cannot unsubscribe to it.

18. The Instant Messaging System of claim 14, where the System Manager can create, add, edit, delete calendar templates through the Configuration Manager that are used to describe the user working hours or to describe the device active schedule.

19. The Instant Messaging System of claim 14, where process variables are available to users for plotting through the Configuration Manager and where the System Administrator can draw graphics that will be associated with devices' process graphics windows.

20. The Instant Messaging System of claim 14, where the System Administrator can create through the Configuration Manager, user groups of one or more users and of one or more devices, and define tasks templates where users can assign predefined tasks to other users.

21. The Instant Messaging System of claim 14, where the System Administrator defines, through the Configuration Manager, which device data, and its format, would be recorded in the device journal, or which data a device reads from another device, as well as which data needs to be written to another device. The Configuration Manager stores all configuration information in the database.

22. The Instant Messaging System of claim 1, where the Server Engine provides the Instant Messaging System with basic services such as user texting, user voice and video call conversations and file sharing between users. The Server Engine continually reads the devices' raw data through the protocol connectors and processes it into useful information. It then makes the processed data available to the System Administrator where events, indicators, process variables, and similar actions can used this information.

23. The Instant Messaging System of claim 22, where the Server Engine has six independent modules to perform different functions, comprising: Event Module, KPI Module, Trending Module, Task Module, Calendar Module, and Notification Module.

24. The Instant Messaging System of claim 22, where the Event Module supervises the different events' triggering conditions and, when a defined event activates, it sends the request for notification to the Notification Module.

25. The Instant Messaging System of claim 22, where the Key Performance Indicator Module supervises the different indicators' values and, when an indicator value goes beyond its limits, it sends a request for notification to the Notification Module.

26. The Instant Messaging System of claim 22, where the Trending Module stores the values for the selected process variables of the devices and for the selected time frame.

27. The Instant Messaging System of claim 22, where the Task Module handles all the transactions that are need for the tasks' management, and it can also create automatically new tasks upon the triggering of an event.

28. The Instant Messaging System of claim 22, where the Calendar Module continually verifies that users are on working hours, as well as determining if the devices are on their active schedule.

29. The Instant Messaging System of claim 22, where the Notification Module notifies users about alerts regarding events, key performance indicators and tasks. The notification is conducted via email, Short Message Service, and through a special Contact that all users have in their IMS. This Contact notifies users about the alerts of the events and the alerts of the key performance indicators that they own or, to which they have subscribed, as well as notifying the users of new tasks that have been assigned to them. Users can select if they want to be notified out of working hours.

30. The Instant Messaging System of claim 22, where the Server Engine records messages and data, in the predefined format, on each device journal, and continually provides data and supports services to the Instant Messaging Client Component Connectors so that users can keep in touch and updated.

31. The Instant Messaging System of claim 22, where through the Instant Messaging System Client, people in real time can, for each device contact:
Read each device operation journal, as well as people's comments on that device,
Plot process variables related to it,
View the device's animated process graphics,
Get the devices' main key performance indicators,
Be notified of the devices' events he/she owns, or to which he/she has subscribed, along with the specific date and time.
Assign tasks to people and follow-up on tasks for that device in order to solve problems and to support continuous improvement,
Get the device's statistics,
Control the device functions.

32. The Instant Messaging System of claim 22, where through the Instant Messaging System Client, people in real time can, for each user contact:
Text message,
Voice Call,
Video Call,
Assign and follow-up tasks in order to solve problems and support continuous improvement,
Follow-up delegated tasks,
Get the key performance indicators for an area or group of people.

33. The Instant Messaging System of claim 22, where devices can, in real time for each device, read data from a device and control at least one device function.
